(19) United States
(12) Patent Application Publication
(10) Pub. No.: US 2002/0159454 A1
(43) Pub. Date: Oct. 31, 2002

(54) Method of protecting data packets against errors

(76) Inventor: Gilles Delmas, Epinay-sous Senart Franc (FR)

Correspondence Address: Philips Electronics North America Corporation, 580 White Plains Road, Tarrytown, NY, 10591, US

(21) Appl. No.: 10/095,550

(22) Filed: Mar. 12, 2002

(30) Foreign Application Priority Data
Mar. 13, 2001 (FR) 0103414

(51) Int. Cl. H04L 12/28

(52) U.S. Cl. 370/389; 370/394

(57) ABSTRACT

The invention proposes a method of protecting data packets against errors, which method comprises generating S error correction packets for N data packets, an error correction packet Yᵢ (where i is a natural integer between 0 and S−1) being generated based on N/S data packets X_{i+jS} (j=0, . . . , N/S−1).

The invention permits to recover up to S consecutive data packets lost during transmission from the time that the difference between two consecutive lost packet groups is greater than N.

### FIELD OF THE INVENTION

The present invention relates to a system comprising at least a source entity and a destination entity, said source entity being intended to deliver data packets and error correction packets to said destination entity.

The invention also relates to a transmitter intended to transmit data packets and error correction packets, and a receiver intended to receive data packets and error correction packets, and comprising at least data packet loss detection means and data packet recovery means.

The invention also relates to a method of protecting data packets against errors, a method of recovering lost data packets and computer programs comprising instructions for implementing said methods.

The invention finally relates to a stream of error correction packets.

The invention has interesting applications in the field of packet transmissions. It applies, for example, to the transmission of data over the Internet and particularly to the transmission of data over the Internet based on wireless access networks.

### BACKGROUND OF THE INVENTION

The document “Request For Comment 2733” published by the IETF (Internet Engineering Task Force) describes an example of an error protection mechanism known by the name of FEC (Forward Error Correction). The FEC mechanism entails the addition of redundancy to transmitted data. This redundancy is transmitted in error correction packets (also called FEC packets). The redundancy permits to re-assemble packets lost during transport. In RFC 2733, the FEC packets are generated by applying an exclusive OR operation to various data packets. Various generating schemes for FEC packets are proposed in paragraph 4 of RFC 2733.

### SUMMARY OF THE INVENTION

It is an object of the invention to propose another scheme which is particularly effective when the errors are expected to affect various consecutive packets, which is notably the case in wireless transmissions because of the poor quality of the radio links.

This object is achieved with a system according to the invention and as described in the opening paragraph in that S error correction packets Y₀, . . . Y_{S-1} are produced for N data packets X₀, . . . , X_{N-1}, while an error correction packet Yᵢ (where i is a natural integer between 0 and S−1) is generated based on N/S data packets X_{i+jS} with j=0, . . . , N/S−1.

The scheme proposed by the invention permits to recover (or re-assemble) up to S consecutive packets insofar as the distance between two groups of packets to be recovered is higher than N.

A transmitter according to the invention comprises means for generating an error correction packet Yᵢ (where i is a natural integer between 0 and S−1) based on N/S data packets X_{i+jS} (j=0, . . . , N/S−1), and means for transmitting S error correction packets Y₀, . . . , Y_{S-1} for N data packets X₀, . . . , X_{N-1.}

For recovering a data packet Xₖ, with k=i+pS (where i, p and S are natural integers), a receiver according to the invention utilizes N/S−1 data packets X_{i+jS}, with j=0, . . . , N/S−1 and j≠p, and an error correction packet Yᵢ which is a function of the N/S data packets X_{i+jS} (j=0, . . . , N/S−1).

In an advantageous embodiment of the invention, said data packets, on the one hand, and said error correction packets, on the other, form two separate packet streams which are produced and may be obtained independently of each other. This embodiment permits a receiver to receive only the data packet stream, or the data packet stream and the error correction packet stream, depending on whether the receiver can either or not use the error correction packet stream or whether the receiver either or not needs to receive this stream.

An error correction packet stream according to the invention comprises packets Yᵢ which are a combination of N/S data packets X_{i+jS} (j=0, . . . , N/S−1) where i, N, S and N/S are natural integers.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 is a diagram of an example of a system according to the invention,

FIG. 2 is a diagram of an IP/UDP/RTP datagram,

FIG. 3 is a diagram describing the operation of an example of a transmitter according to the invention, and

FIG. 4 is a diagram describing the operation of an example of the receiver according to the invention.

### DESCRIPTION OF A PREFERRED EMBODIMENT

FIG. 1 shows by way of example a system according to the invention, which comprises a source entity and a destination entity. In this example the source entity is a transmitter 10 and the destination entity is a receiver 20. The transmitter 10 and the receiver 20 are connected by a transmission channel 30 comprising, for example, a radio channel. In the example that has just been described, the transport protocol used is RTP over UDP over IP. This is not restrictive. RTP (Real-time Transport Protocol) and UDP (User Datagram Protocol) are protocols of the transport layer defined in RFC 1889 and 0768 of the IETF, respectively. The IP protocol (Internet Protocol) is a protocol of the network layer defined for the version 4 by RFC 0791 and for the version 6 by RFC 1883 of the IETF. In the following only the elements necessary for understanding the invention will be described. For more details reference is made to the above-mentioned RFC.

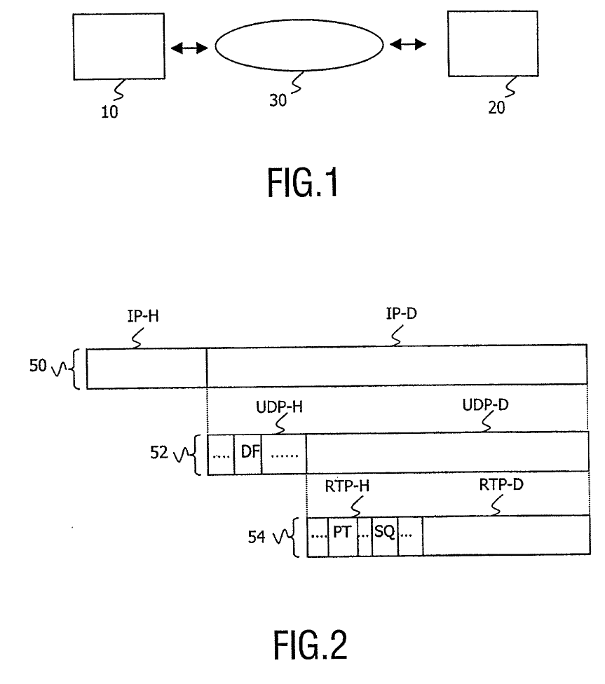

FIG. 2 shows a IP datagram which contains a UDP datagram containing itself a RTP packet.

According to FIG. 2 a IP datagram referred to as 50 comprises a header IP-H and a data field IP-D. The data field IP-D contains a UDP datagram referred to as 52. The UDP datagram 52 contains a header UDP-H and a data field UDP-D. The data field UDP-D contains a RTP packet which is referred to as 54. This RTP packet 54 contains a header RTP-H and a data field RTP-D.

When the RTP packet is a data packet, the data field RTP-D contains useful data, for example, coded data delivered by a video MPEG-4 coder. When the RTP packet is an error correction packet, the data field RTP-D contains error correction data.

The header RTP-H of the RTP packet contains, inter alia, a type field denoted PT, which indicates the type of the data contained in the data field RTP-D, and a sequence number field, denoted SQ, which is incremented by unity each time a RTP packet is sent so as to allow the receiver to detect the loss of a packet.

The header UDP-H of the UDP datagram contains, inter alia, a destination field DF which indicates the destination of the UDP datagram.

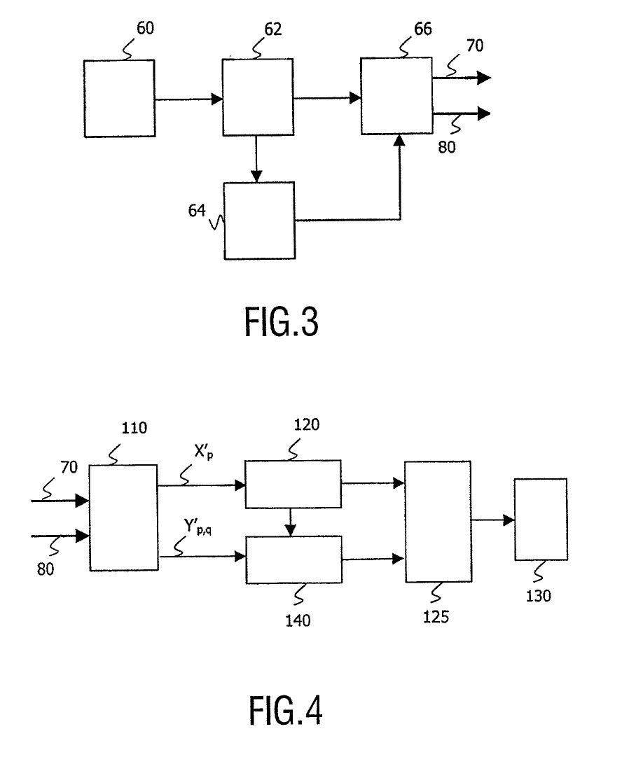

The RFC 2773 of the IETF describes the format of the data field RTP-D of an error correction packet called packet FEC. According to RFC 2773 the data field RTP-D of a packet FEC comprises a header FEC denoted FEC-H, followed by a data field FEC denoted FEC-D. The header FEC-H contains, inter alia, a field SN and a field MASK. The field SN indicates the basic sequence number M of the data packets protected by this packet FEC. The field MASK is a field of 24 bits. When a bit i of the field MASK is put to “1”, this means that the data packet having sequence number M+i [modulo 65536] is protected by this packet FEC. FIG. 3 shows a diagram describing the operation of the transmitter 10. According to FIG. 3 a coding block 60 delivers coded data to a packetizing block 62. The packetizing block 62 delivers RTP data packets denoted Xₚ (p being a natural integer). These data packets Xₚ are applied, on the one hand, to an error correction packet generating block 64 and, on the other hand, to a transmission block 66. The error correction packet generating block 64 generates S error correction packets Y_{p,q}, with q=0, . . . , S−1 for N data packets Xₚ, . . . , X_{p+N-1}. According to the invention each error correction packet Y_{p,q} is generated based on the N/S data packets X_{p+q+jS} with j=0, . . . , N/S−1.

The error correction packets Y_{p,q} are then applied to the transmission block 66 which encapsulates the RTP packets in UDP datagrams which are themselves encapsulated in datagrams IP, and transmits the datagrams IP resulting therefrom.

In an advantageous manner, the transmission block 66 delivers two separate streams, one stream 70 relating to the data packets and one stream 80 relating to the error correction packets. In practice these two streams correspond to two different RTP sessions, that is to say, to two different destination ports DF in the UDP datagrams.

When the data packets and the error correction packets form a single stream transmitted in a single session, the error correction packets must be transmitted after N data packets to which they relate, so as to effectively permit to correct up to S consecutive losses. In that case, the type field PT is advantageously used for distinguishing the data packets from the error correction packets.

FIG. 4 shows a diagram describing the operation of the receiver 20. According to FIG. 4, a receiving block 110 receives the streams 70 and 80 and delivers data packets X′ₚ and error correction packets Y′_{p,q}. A detection block 120 verifies the sequence numbers SQ contained in the data packet headers, so as to detect possible losses of data packets. The data packets are then applied to a block 125 for reconstructing the stream. When the detection block 120 detects that a data packet X′ₘ (m=i+kS=aN+b where i, k, a and b are natural integers) has been lost, a recovery block 140 executes recovery operations of the data packet based on the N/S−1 data packets X′_{i+jS} with j=0, . . . , N/S−1 and j≠k, and based on the error correction packet Y′_{a,i} (the field SN and the field MASK of the header of the error correction packet Y′_{a,i} indicate the data packets to be used). These recovery operations are brought to a successful issue if the data packets X′_{i+jS} (j=0, . . . , N/S−1 and j≠k) and the error correction packet Y′_{a,i} have been received correctly. In that case the recovered packet is transmitted to the stream reconstruction block 125. The stream reconstruction block 125 reconstructs a stream of data packets by inserting the packets reconstructed by the block 140 into the data packet stream coming from block 120. The reconstructed stream is then delivered to an application block (an MPEG-4 decoding block in this example) referred to as 130. On the other hand, if one or more data packets X′_{i+jS} (j=0, . . . , N/S−1 and j≠k) or if the error correction packet Y′_{a,i} has not been received correctly, the lost data packet X′ₘ cannot be recovered.

Finally, the recovery block 140 is thus capable of recovering up to S consecutive packets at its maximum, provided that the distance between the groups of lost packets is greater than N (it is evidently possible that only certain packets of the group are lost: in fact the block 140 is capable of recovering any number lower than or equal to S of consecutive or non-consecutive packets, provided that the distance between the groups of lost packets is higher than N). The integers S and N are thus to be chosen as a function of the number of consecutive packets that may be lost, of the probable distance between two groups of lost packets and of the desired protection ratio (for regulating the protection ratio, N may be reduced or augmented).

In a general manner, when S error correction packets are added for N data packets, the number of packets to be transmitted is augmented by (S/N)%.

Now will be given an example of generating error correction packets and an example of recovering lost packets in a particular case, so as to illustrate that which has just been described. In this example, N is chosen to be 24 and S to be 3. Let X₀, X₂, . . . , X₂₃ be twenty-four consecutive data packets. The error correction packets corresponding to these 24 data packets are the 3 packets Y_{0,0}, Y_{0,1} and Y_{0,2} obtained in the following manner:

Y_{0,0}=X₀⊕X₃⊕X₆⊕X₉⊕X₁₂⊕X₁₅⊕X₁₈⊕X₂₁

Y_{0,1}=X₁⊕X₄⊕X₇⊕X₁₀⊕X₁₃⊕X₁₆⊕X₁₉⊕X₂₂

Y_{0,2}=X₂⊕X₅⊕X₈⊕X₁₁⊕X₁₄⊕X₁₇⊕X₂₀⊕X₂₃

For example, if one or more of the three consecutive packets X₆, X₇ and X₈ are lost:

the packet X₆ will be recovered based on the data packets X₀, X₃, X₉, X₁₂, X₁₅, X₁₈ and X₂₁, and based on the error correction packet Y_{0,0}

the packet X₇ will be recovered based on the data packets X₁, X₄, X₁₀, X₁₃, X₁₆, X₁₉ and X₂₂, and based on the error correction packet Y_{0,1}

the packet X₈ will be recovered based on the data packets X₂, X₅, X₁₁, X₁₄, X₁₇, X₂₀ and X₂₃, and based on the error correction packet Y_{0,2}.

In this particular case the increase of the number of packets transmitted because of the FEC protection is 12.5%.

The number N may be higher than 24 although the field MASK contains only 24 bits. By way of example, N may be chosen to be 25 and S to be 5. In that case, 5 error correction packets Y_{0,0}, Y_{0,1}, Y_{0,2}, Y_{0,3} and Y_{0,4} are formed based on the 25 data packets X₀, X₂, . . . , X₂₄:

Y_{0,0}=X₀⊕X₅⊕X₁₀⊕X₁₅⊕X₂₀

Y_{0,1}=X₁⊕X₆⊕X₁₁⊕X₁₆⊕X₂₁

Y_{0,2}=X₂⊕X₇⊕X₁₂⊕X₁₇⊕X₂₂

Y_{0,3}=X₃⊕X₈⊕X₁₃⊕X₁₈⊕X₂₃

Y_{0,4}=X₄⊕X₉⊕X₁₄⊕X₁₉⊕X₂₄

In this case the fields SN of the error correction packets Y_{0,0} and Y_{0,4} do not contain the same basic sequence number: the field SN of the packet Y_{0,0} contains the sequence number of the packet X₀; and the field SN of the packet Y_{0,4} contains the sequence number of the packet X₄.

The invention is not restricted to the embodiment that has just been described by way of example. More particularly:

It is not restricted to the use of an exclusive OR operation for generating the error correction packets. It is applicable to any type of error correction code, notably to the convolution codes or block codes.

It is possible to use another packet transport layer than UDP/IP. For example, when the transmission takes place in accordance with the Bluetooth standard, the transport layer used is L2CAP. Nor is the invention restricted to the use of the RTP protocol.

The presence of a coding block is not mandatory. Non-coded data, for example text, can be protected.

In the embodiment that has just been described, the error correction packets apply to complete data packets. But the invention can also be used with a multilevel protection such as described, for example, in the document “An RTP Payload Format for Generic FEC with Uneven Level Protection” published by the IETF on Nov. 15, 2000. In that case the error correction packets apply only to a part of each data packet and no longer on the whole packets. The length of the parts used for calculating an error correction packet may vary as a function of the importance of the data contained in the data packets to be protected.

Finally, the invention has been described in the case of a radio transmission between two remote pieces of equipment. But the invention may also be applied to a source entity formed by a data carrier medium and to a destination formed by reading equipment for reading a contents stored on said medium. In that case the errors are not caused by a transmission channel, but by the reading operation itself.

1. A system comprising at least a source entity and a destination entity, said source entity being intended to deliver data packets and error correction packets to said destination entity, characterized in that S error correction packets Y₀, . . . , Y_{S-1} are produced for N data packets X₀, . . . , X_{N-1}, while an error correction packet Yᵢ (where i is a natural integer between 0 and S−1) is generated based on N/S data packets X_{i+jS} with j=0, . . . , N/S−1.

2. A system as claimed in claim 1, characterized in that said data packets, on the one hand, and said error correction packets, on the other, form two separate packet streams which are produced and may be obtained independently of each other.

3. A transmitter intended to transmit data packets and error correction packets, characterized in that it comprises means for generating an error correction packet Yᵢ (where i is a natural integer between 0 and S−1) based on N/S data packets X_{i+jS} (j=0, . . . , N/S−1), and means for transmitting S error correction packets Y₀, . . . , Y_{S-1} for N data packets X₀, . . . , X_{N-1}.

4. A transmitter as claimed in claim 3, characterized in that it comprises means for forming a data packet stream and an error correction packet stream which are independent of each other, said streams being intended to be transmitted independently of each other.

5. A receiver intended to receive data packets and error correction packets, comprising at least data packet loss detection means and data packet recovering means, characterized in that, for recovering a data packet Xₖ with k=i+pS (where i, p and S are natural integers), said recovering means use an error correction packet Yᵢ which is a function of N/S data packets X_{i+jS} (j=0, . . . , N/S−1), and N/S−1 data packets X_{i+jS} with j=0, . . . , N/S−1 and j≠p.

6. A method of protecting data packets against errors, comprising a step of generating error correction packets based on said data packets, and a step of delivering said error correction packets, characterized in that said step of generating error correction packets comprises the generating of an error correction packet Yᵢ (where i is a natural integer between 0 and S−1) based on the N/S data packets X_{i+jS} (j=0, . . . , N/S−1), while said step of delivering error correction packets comprises the delivery of S error correction packets Y₀, . . . , Y_{S-1} for N data packets X₀, . . . , X_{N-1}.

7. A method of protecting data packets against errors as claimed in claim 6, characterized in that it comprises a step of forming a stream of data packets and a stream of error correction packets which are independent of each other, said streams being intended to be delivered independently of each other.

8. A computer program product comprising instructions for implementing a method of protecting data packets against errors as claimed in one of the claim 6 or 7.

9. A method of recovering lost data packets, based on data packets and error correction packets, characterized in that it comprises the use of an error correction packet Yᵢ which is a function of the N/S data packets X_{i+jS} (j=0, . . . , N/S−1), and N/S−1 data packets X_{i+jS} with j=0, . . . , N/S−1 and j≠p to recover a data packet Xₖ with k=i+pS (where i, p and S are natural integers),

10. A computer program product comprising instructions for implementing a method of recovering data packets as claimed in claim 9.

11. Error correction packet stream of which the packets Yᵢ are a combination of N/S data packets X_{i+jS} (j=0, . . . , N/S−1), i, N, S and N/S being natural integers.
